(19) United States
(12) Patent Application Publication
(10) Pub. No.: US 2005/0091385 A1
(43) Pub. Date: Apr. 28, 2005

(54) Method and system for children to safely send and receive electronic mail

(76) Inventor: James Nordstrom, Mountainside, NJ (US)

Correspondence Address: James Nordstrom, 1086 Sunny Slope Drive, Mountainside, NJ, 07092, US

(21) Appl. No.: 10/695,224

(22) Filed: Oct. 28, 2003

(51) Int. Cl. G06F 15/16

(52) U.S. Cl. 709/228

(57) ABSTRACT

A method and system for children to safely send and receive electronic mail. When an electronic mail message is sent to a child; a server system intercepts the electronic mail message, redirecting the electronic mail message to the account of the child's, parent. The parent reviews the electronic mail message, and based on the parent's discretion deletes or forwards the electronic mail message to the child's account. When a child sends an electronic mail message, a server system intercepts the electronic mail message, redirecting the electronic mail message to the account of the child's parent. The parent reviews the electronic mail message and based on the parent's discretion deletes or forwards the electronic mail message to the electronic mail message's addressees. The interception, temporary storage and forwarding of electronic mail messages are transparent to both the sender and receiver.

### TECHNICAL FIELD

This present invention relates to a computer method and system for protecting children and more particularly to a method and system for protecting children while sending and receiving electronic mail.

### BACKGROUND OF THE INVENTION

Electronic mail is an electronic messaging system which enables individuals to send electronic mail messages to one another using computing devices which are interconnected via a communications network, the most popular communications network is the Internet.

Every individual sending or receiving electronic mail messages must have at least one electronic mail account. Each electronic mail account has an associated unique electronic mail address which differentiates the electronic mail account from other electronic mail accounts.

An electronic mail address, takes the form of name@domain where name is the username of an individual with an electronic mail account and domain is the address of a computer or group of computers connected to a computer network which provide electronic mail services. Electronic mail services consist of retrieving, receiving, sending, storing, sorting and forwarding electronic mail messages. An electronic mail address is similar to a postal address as it defines a unique location to which an electronic mail message should be delivered.

Electronic mail accounts are hosted on electronic mail servers. To check for new electronic mail messages, review existing electronic mail messages or compose a new electronic mail message, an individual uses a Standard Electronic Mail Client or a Web Based Electronic Mail Client. A Standard Electronic Mail Client is any software executing on a computing device which can send, store and retrieve electronic mail messages over a communications network using industry standard electronic mail protocols. Examples of Standard Electronic Mail Client computing devices are computer servers, computer desktops, computer laptops, tablet PCs, computer notebooks, Personal Digital Assistances (PDAs), Pocket PCs (PPC), cellular/mobile/GSM and other phone technologies. A Web Based Electronic Mail Client is an electronic mail client which uses a Web Browser, HTTP and/or HTTPS protocols, a Web Server and in some cases an Application Server or other server components as an interface or wrapper to a Standard Electronic Mail Client.

The body or content of an electronic mail message can consist of text, HTML, images, audio, video and flash animations.

Electronic mail was created in the nineteen seventies. In the early nineteen nineties the Internet went main stream and electronic mail became a popular communications medium. Billions of electronic mail messages are sent and received daily.

While the early adapters of the Internet were mostly adults, the increased simplicity of computers and a growing number of Internet connectivity options have brought large numbers of children online. As of today, it is estimated that 45 million American children are connected to and actively using the Internet.

With a growing number of children comes a growing number of individuals who wish to harm these children. These individuals use the anonymity of the Internet to disguise their identity. Some even pose as children in an effort to gain a child's trust.

Electronic mail was designed as an open communication system. As such, any electronic mail message send by anyone from anywhere is delivered to the electronic mail message's addressee, regardless of the content of the electronic mail message or the age of the addressee.

While an open environment is acceptable to adults it is not suitable for children.

An open environment does not prevent inappropriate, sexually explicit and dangerous electronic mail messages from being delivered directly to a child's electronic mail account.

To address the issue of inappropriate, sexually explicit and dangerous electronic mail messages, computer based electronic mail filters were created. Computer based electronic mail filters use a technology called pattern matching; these filters match predefined key words or a set of pre defined words. Each electronic mail message is screened for a matching word or set of words. If a match is discovered, the electronic mail message is deleted.

The problem with electronic mail filters is that they are computer based and while electronic mail filters offer an improvement over an open electronic mail system, electronic mail filters fail to filter all messages.

Advertisers and spammers, individuals who deliberately send bulk unsolicited electronic mail messages, have developed clever ways to defeat electronic mail filters. For example advertisers and spammers deliberately change the spelling of a word, use words with dual meaning or insert random characters into a word. As a result these electronic mail messages will pass the electronic mail filter check and be delivered directly to a child's account.

More importantly being key word based, computer based electronic mail filters fail to filter intent, electronic mail messages that do not match a key word or group of words, but still pose a threat to children. Electronic mail messages sent from older peers can contain discussions of sexually, drug use, depression, suicide and violence. Electronic mail messages sent from pedophiles and other dangerous individuals can be used to establish contact with a child.

### SUMMARY OF THE INVENTION

An embodiment of the present invention provides a method and system for children to safely send and receive electronic mail. When an individual or system sends an electronic mail message addressed to a child, the electronic mail message is intercepted and redirected to the electronic mail account of the child's parent. If the parent deems the electronic mail message appropriate and explicitly forwards the electronic mail message from their electronic mail account to the child's electronic mail account, then, and only then, will the electronic mail message become visible to the child. If the parent deems the electronic mail message inappropriate, the parent can delete the electronic mail message, in turn preventing the child from receiving the electronic mail message. When a child sends an electronic mail message, the electronic mail message is intercepted and redirected to the electronic mail account of the child's parent and not to the intended addressees' electronic mail accounts. Once the parent reviews and deems the electronic mail message appropriate, the parent can forward the electronic mail message from their account to the electronic mail message's original addressees. If the parent deems the electronic mail message inappropriate, the parent can delete the electronic mail message, preventing the intended recipient from receiving the electronic mail message. To control the flow of electronic mail messages sent to and from a child, a parent using a Web Browser, logs into the system's Web Server, selects an electronic mail account belonging to one of their children and selectivity forwards or deletes incoming and outgoing electronic mail messages. Children use a custom Web Based Electronic Mail Client, a Standard Electronic Mail Client or any computing device which is capable of sending and receiving electronic mail messages. The interception, temporary storage and forwarding of electronic mail messages are transparent to both the sender and receiver of an electronic mail message.

### BRIEF DESCRIPTION OF THE DRAWINGS

FIG. 1 is a block diagram illustrating one embodiment of the present invention.

FIG. 2 is a flow diagram of a routine which enables a child to send an electronic mail message via a Web Based Electronic Mail Client.

FIG. 3 is a flow diagram of a routine which processes an electronic mail message sent from a child via a Web Based Electronic Mail Client.

FIG. 4 is a flow diagram of a routine which enables a child to send an electronic mail message via a Standard Electronic Mail Client.

FIG. 5 is a flow diagram of a routine which processes an electronic mail message sent from a child via a Standard Electronic Mail Client.

FIG. 6 is a flow diagram of a routine which enables an individual to send an electronic mail message to a child.

FIG. 7 is a flow diagram of a routine which processes an electronic mail message sent to a child.

FIG. 8 is a flow diagram of a routine which enables a child to view new electronic mail messages.

FIG. 9 is a flow diagram of a routine which processes a child request to view new electronic mail messages.

FIG. 10 is a flow diagram of a routine which enables a parent to view new electronic mail messages.

FIG. 11 is a flow diagram of a routine which processes a parent request to view new electronic mail messages.

FIG. 12 is a flow diagram of a routine which enables a parent to forward one or more electronic mail messages to a child's account.

FIG. 13 is a flow diagram of a routine which processes a parent request to forward one or more electronic mail messages to a child's account.

FIG. 14 is a flow diagram of a routine which enables a parent to delete one or more electronic mail messages.

FIG. 15 is a flow diagram of a routine which processes a parent's request to delete one or more electronic mail messages.

FIG. 16 is a flow diagram of a routine which enables a parent to forward one or more electronic mail messages to the messages addressees.

FIG. 17 is a flow diagram of a routine which processes a parent's request to forward one or more electronic mail messages to the messages addressees.

FIG. 18 is a flow diagram of a routine which enables a parent to forward one or more electronic mail messages to an authority.

FIG. 19 is a flow diagram of a routine which processes a parent's request to forward one or more electronic mail messages to an authority.

FIGS. 20A-20C illustrate a hierarchical data entry mechanism in one embodiment.

### DETAILED DESCRIPTION OF THE INVENTION

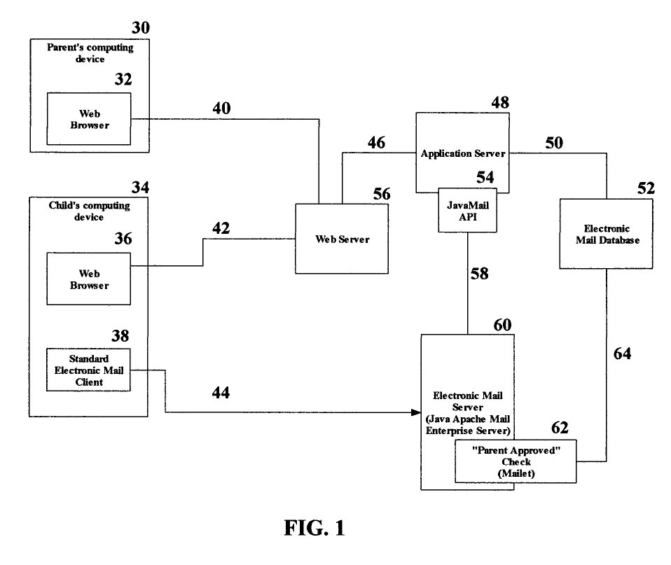

The present invention provides a method and system for children to safely send and receive electronic mail. FIGS. 1 through 20 illustrate one embodiment of the present Invention.

FIG. 1 is a block diagram illustrating one embodiment of the present invention. This embodiment supports a child safely sending and receiving electronic mail messages over a communications network. A child on his/her computing device 34, using a Web Based Electronic Mail Client 36, composes and sends an electronic mail message via a communications network 42 to the Web Server 56 the Web Server 56 forwards the request which encompasses the electronic mail message to the Application Server 48 via a communications network 46. The Application Server 48 deposits the electronic mail message into the Electronic Mail Database 52 via a communications network 50. A child on his/her computing device 34 using a Standard Electronic Mail Client 38 composes and sends an electronic mail message. The Standard Electronic Mail Client 38 sends the electronic mail message to the system's Electronic Mail Server 60 via a computer network 44. The system's Electronic Mail Server 60 uses a Maillet 62 to inspect the electronic mail message for a “Parent Approved” indicator. If a “Parent Approved” indicator is found within the electronic mail message, the Maillet 62 forwards the electronic mail message to one or more electronic mail servers for which the electronic mail message is addressed. If the “Parent Approved” indicator is not found within the electronic mail message the Maillet 62 deposits the electronic mail message into the Electronic Mail Database 52 via a communications network 64. An individual or computer system sends an electronic mail message addressed to a child. The system's Electronic Mail Server 60 using a Maillet 62 inspects the electronic mail message for a “Parent Approved” indicator. If a “Parent Approved” indicator is found within the electronic mail message, the Maillet 62 forwards the electronic mail message to the child's electronic mail account. If the “Parent Approved” indicator is not found within the electronic mail message the Maillet 62 deposits the electronic mail message into the Electronic Mail Database 52 via a communications network 64. A parent on his/her computing device 30 using a Web Browser 32 connects to the Web Server 56 via a communications network 40. The Web Server 56 forwards the request to the Application Server 48 via a communications network 46. The Application Server 48 queries the Electronic Mail Database 52 via a communications network 50 for electronic mail messages that require review. The Electronic Mail Database 52 returns a list of electronic mail messages to the Application Server 48 via a communications network 50. The Application Server 48 returns the list of electronic mail messages to the Web Server 56 via a communications network 46. The Web Server 56 returns the list of electronic mail messages to the parent's Web Browser 32, as a web page for display, via a communications network 40. The parent reviews the list of electronic mail messages, selecting one or more electronic mail messages that require action. If the parent's request includes an instruction to forward the selected electronic mail messages, each electronic mail message is marked “Parent Approved” and using the JavaMail API 54 the electronic mail messages are sent to the Electronic Mail Server 60 via a communications network 58 for delivery. If the parent's request includes an instruction to delete the selected electronic mail messages, the Application Server 48 instructs the Electronic Mail Database 52 to delete the selected Electronic mail messages. The Electronic Mail Database 52 deletes the electronic mail messages.

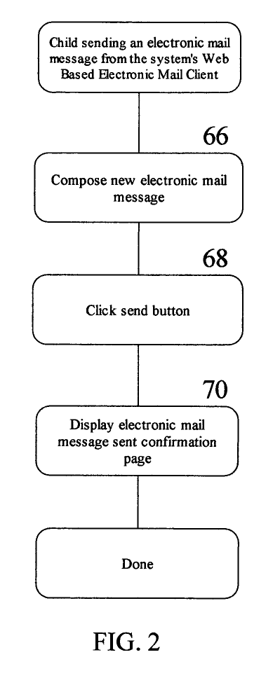

FIG. 2 is a flow diagram of a routine which enables a child to send an electronic mail message via a Web Based Electronic Mail Client. Using a Web Browser 36 a child composes a new electronic mail message 66, clicks on the send button 68 and receives a confirmation page 70.

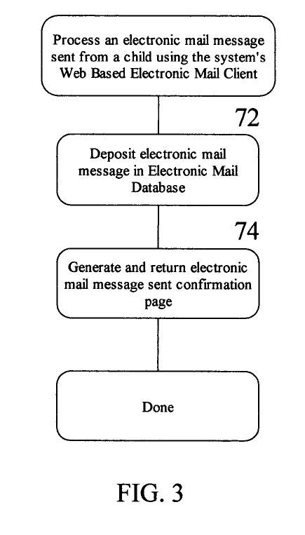

FIG. 3 is a flow diagram of a routine which processes a child's request to send an electronic mail message via a Web Based Electronic Mail Client. In response to the child's request, the child's Web Browser 36 sends a request to the Web Server 56. The Web Server 56 forwards the request to the Application Server 48 and the Application Server 48 deposits 72 the electronic mail message into the Electronic Mail Database 52. The Application Server 48 generates and returns a confirmation page to the Web Server 56. The Web Server 56 returns a confirmation page 74 to the child's Web Browser 36.

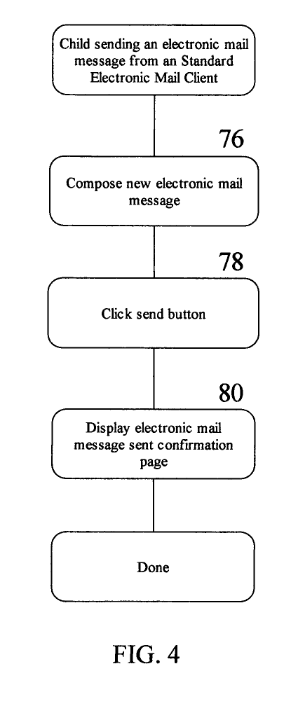

FIG. 4 is a flow diagram of a routine which enables a child to send an electronic mail message via a Standard Electronic Mail Client 38. Using a Standard Electronic Mail Client 38 a child composes a new electronic mail message 76, clicks the send button 78 and received a message sent confirmation page 80.

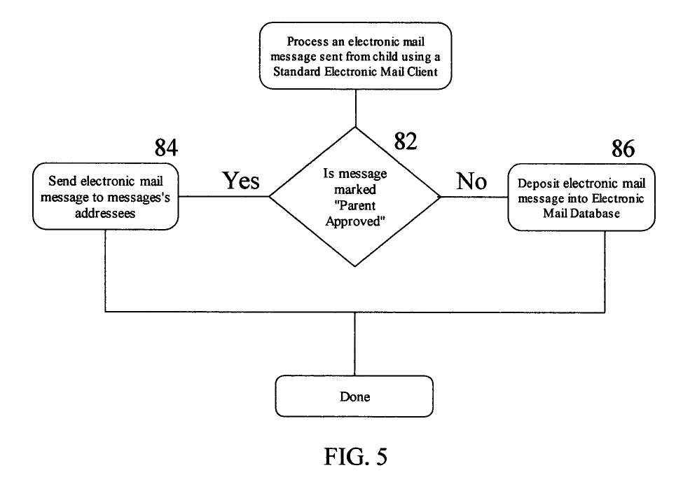

FIG. 5 is a flow diagram of a routine which processes a child's request to send an electronic mail message via a Standard Electronic Mail Client 38. When a child clicks on the send button of a Standard Electronic Mail Client 38, the Standard Electronic Mail Client 38 sends the electronic mail message to the Electronic Mail Server 60. A Maillet 62 on the Electronic Mail Server 60 intercepts and interrogates the electronic mail message for a “Parent Approved” indicator 82. If a “Parent Approved” indicator is found within the electronic mail message, the electronic mail message is forwarded to the electronic mail message's addressees 84. If a “Parent Approved” indicator is not found within the electronic mail message the electronic mail message is deposited 86 into the Electronic Mail Database 60.

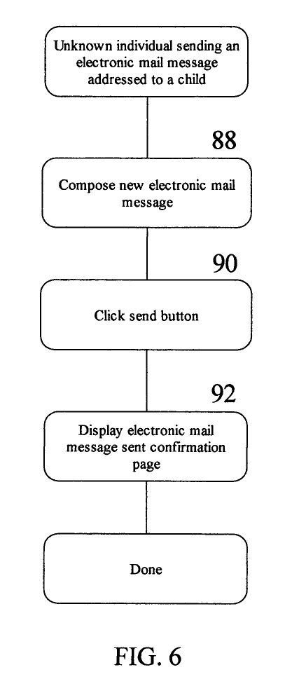

FIG. 6 is a flow diagram of a routine which enables an individual to send an electronic mail message to a child. Using a Web Based Electronic Mail Client, a Standard Electronic Mail Client or any computing device which is capable of sending electronic mail messages, an individual composes a new electronic mail message 88, clicks on a send button 90 and receives an electronic mail message sent confirmation 92.

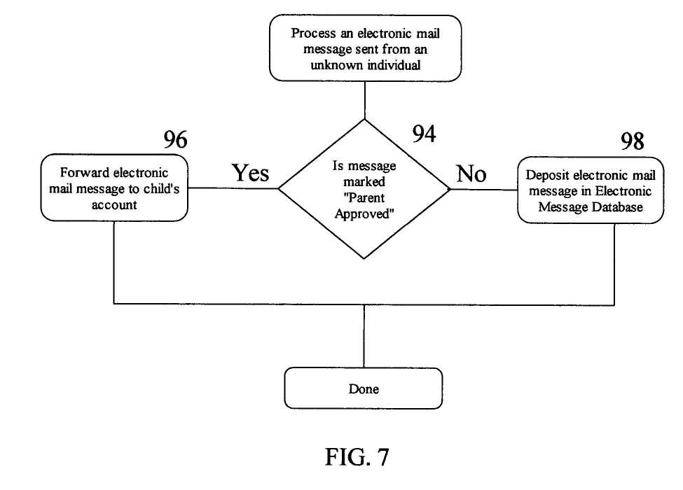

FIG. 7 is a flow diagram of a routine which processes an individual's or computer system's request to send an electronic mail message to a child. When a computer system or individual sends an electronic mail message addressed to a child, the electronic mail message is delivered to the system's Electronic Mail Server 60. The Maillet 62 on the Electronic Mail Server 60 intercepts and interrogates the electronic mail message for a “Parent Approved” indicator 94. If a “Parent Approved” indicator is found within the electronic mail message, the electronic mail message is forwarded to the child's account 96. If a “Parent Approved” indicator is not found within the electronic mail message, the electronic mail message is deposited into the Electronic Mail Database 98.

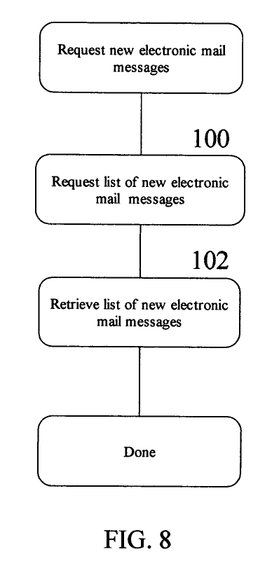

FIG. 8 is a flow diagram of a routine which enables a child to query their account for new or existing electronic mail messages. Using a Web based Electronic Mail Client 36 or a Standard Electronic Mail Client 38 a child queries system for a list of new or existing electronic mail messages 100. The system returns a list of new or existing electronic mail messages 102.

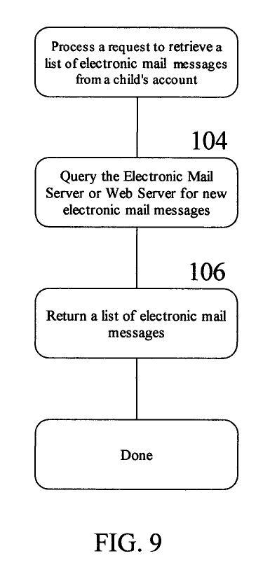

FIG. 9 is a flow diagram of a routine which processes a child's request for a list of new or existing electronic mail messages. If the child is using a Standard Electronic Mail Client 38, the child's Standard Electronic Mail Client 38 queries the Electronic Mail Server 60 for a list of new or existing electronic mail messages 104. The Electronic Mail Server 60 returns a list of new or existing electronic mail messages 106. If the child is using a Web Based Electronic Mail Client, the child's Web Browser 36 queries the Web Server 56 for a list of new or existing electronic mail messages 104. The Web Server 56 forwards the request to the Application Server 48. The Application Server 48 queries the Electronic Mail Server 60 for new or existing electronic mail messages. The Application Server 48 returns the list of new or existing electronic mail messages to the Web Server 56 and in turn the Web Server 56 returns the list of new or existing electronic mail messages 106 to the child's Web Browser 36.

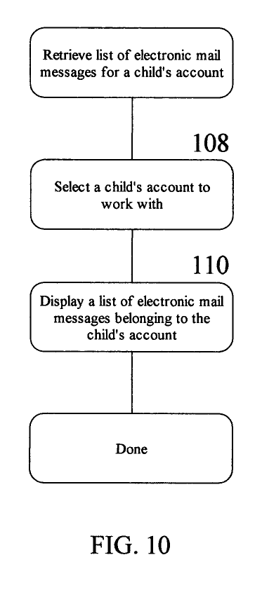

FIG. 10 is a flow diagram of a routine which enables a parent to view a list of electronic mail messages which had previously been stored in the Electronic Mail Database 52. Using a Web Browser 32 a parent selects a child's account to review from a list of children for which they are responsible 108. The system returns a list of electronic mail messages 110 for that child.

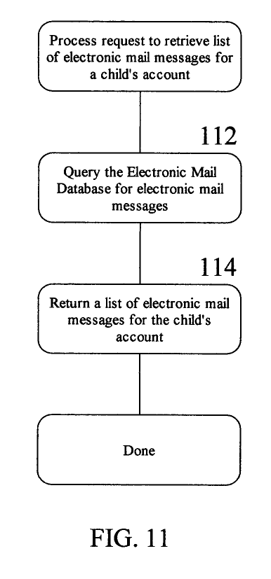

FIG. 11 is a flow diagram of a routine which processes a parent's request to view a list of electronic mail messages which had previously been stored in the Electronic Mail Database 52. In response to the parent's request for the list of electronic mail messages the parent's Web Browser 32 sends a request to the Web Server 56. The Web Server 56 forwards the request to the Application Server 48. The Application Server 48 queries the Electronic Mail Database 52 for a list of electronic mail messages 112. The Electronic Mail Database 52 returns a list of electronic mail messages to the Application Server 48 and in turn the Application Server 48 returns the list of electronic mail messages to the Web Server 56. The Web Server returns the list of electronic mail messages 114 to the parent's Web Browser 32.

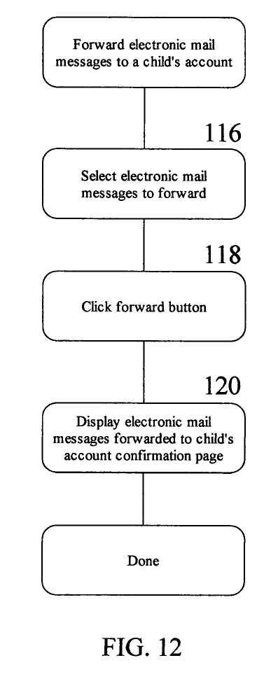

FIG. 12 is a flow diagram of a routine which enables a parent to forward one or more electronic mail messages from the Electronic Mail Database 52 to a child's account. A parent selects one or more electronic mail messages from a list of electronic mail messages to forward 116, clicks the forward button 118 and receives a confirmation page 120.

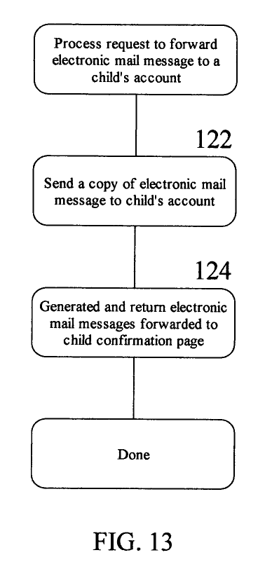

FIG. 13 is a flow diagram of a routine which processes a parent's request to forward one or more electronic mail messages from the Electronic Mail Database 52 to a child's account. In response to the parent's request, the parent's Web Browser 32 sends a request to the Web Server 56. The Web Server 56 forwards the request to the Application Server 48. The Application Server 48 reads the requested electronic mail messages from the Electronic Mail Database 52 and the Application Server 48 marks each message “Parent Approved” using the JavaMail API 54. The Application Server 48 forwards a copy of the electronic mail messages to the Electronic Mail Server 60. The Electronic Mail Server 60 inspects the electronic mail messages, locates the “Parent Approved” indicator and forwards the electronic mail messages to the child's electronic mail account 122. The Application Server 48 generates and returns a confirmation page to the Web Server 56. The Web Server 56 returns the confirmation page 124 to the parent's Web Browser 32.

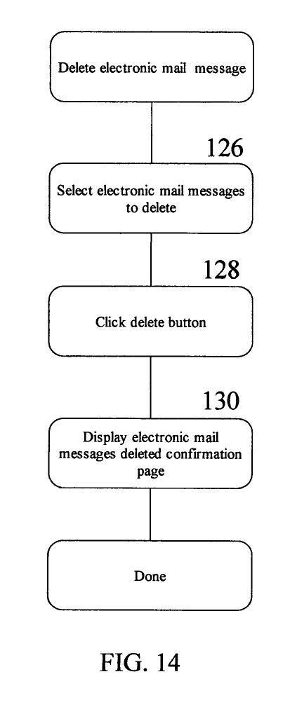

FIG. 14 is a flow diagram of a routine which enables a parent to delete one or more electronic mail messages from a list of electronic mail messages. A parent selects one or more electronic mail messages 126, clicks the delete button 128 and receives a confirmation page 130.

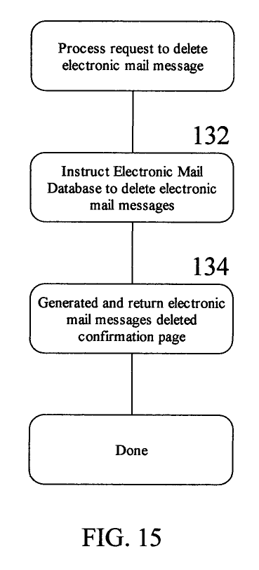

FIG. 15 is a flow diagram of a routine which processes a parent's request to delete one or more electronic mail messages from the Electronic Mail Database 52. In response to the parent's request, the parent's Web Browser 32 sends a request to the Web Server 56. The Web Server 56 forwards the request to the Application Server 48 and the Application Server 48 instructs the Electronic Mail Database 52 to delete the selected electronic mail messages 132. The Application Server 48 generates and returns a confirmation page to the Web Server 56. The Web Server 56 returns the confirmation page 134 to the parent's Web Browser 32.

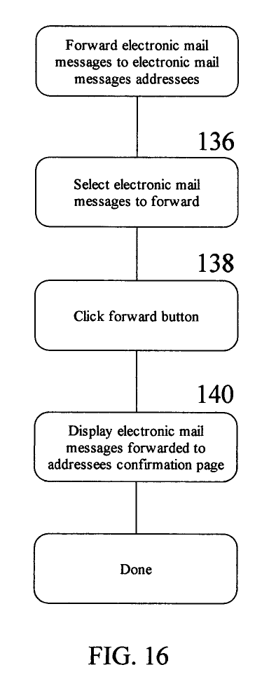

FIG. 16 is a flow diagram of a routine which enables a parent to forward one or more electronic mail messages to the messages addressees. A parent selects one or more electronic mail messages from a list of electronic mail messages 136, clicks the forward button 138 and receives a confirmation page 140.

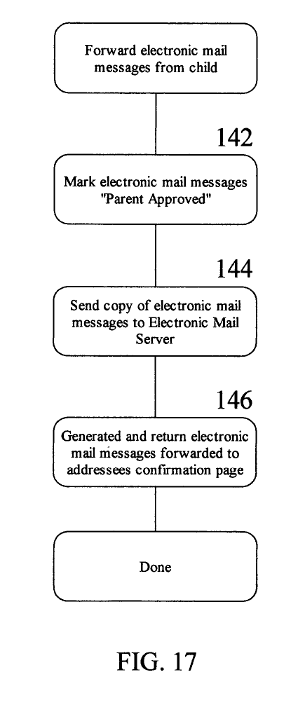

FIG. 17 is a flow diagram of a routine which processes a parent's request to forward one or more electronic mail messages from the Electronic Mail Database 52 to the electronic mail messages addresses. In response to the parent's request, the parent's Web Browser 32 sends a request to the Web Server 56. The Web Server 56 forwards the request to the Application Server 48. The Application Server 48 reads the electronic mail messages from the Electronic Mail Database 52 and the Application Server 48 marks each message “Parent Approved” 142. The Application Server 48, using the JavaMail API 54, forwards a copy of each of the electronic mail messages 144 to the Electronic Mail Server 60. The Electronic Mail Server 60, using the Maillet 62, inspects the electronic mail messages, locates the “Parent Approved” indicator and forwards the electronic mail messages to the electronic mail messages addresses. The Application Server 48 generates and returns a confirmation page to the Web Server 56 and in turn the Web Server 56 returns the confirmation page 146 to the parent's Web Browser 32.

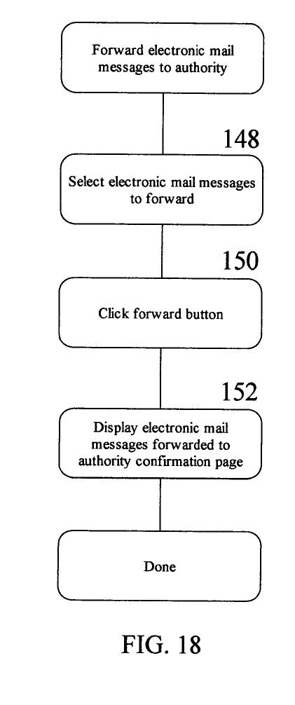

FIG. 18 is a flow diagram of a routine which enables a parent to forward one or more electronic mail messages from the Electronic Mail Database 52 to an authority. A parent selects one or more electronic mail message from a list of electronic mail messages 148, clicks the forward button 150 and receives a confirmation page 152.

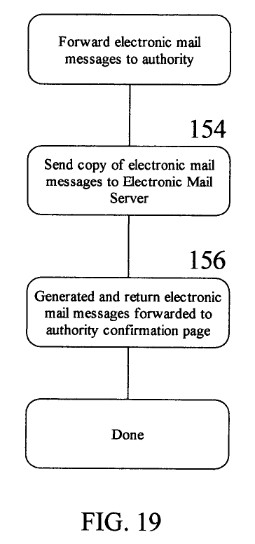

FIG. 19 is a flow diagram of a routine which processes a parent's request to forward one or more electronic mail messages from the Electronic Mail Database 52 to an authority. In response to the parent's request, the parent's Web Browser 32 sends a request to the Web Server 56 and the Web Server 56 in turn forwards the request to the Application Server 48. The Application Server 48 using the JavaMail API 54 sends the electronic mail messages 154 to the Electronic Mail Server 60 and in turn the Electronic Mail Server 60 forwards the electronic mail messages to an authority. The Application Server 48 generates and returns a confirmation page to the Web Server 56 and the Web Server 56 returns the confirmation page 156 to the parent's Web Browser 32.

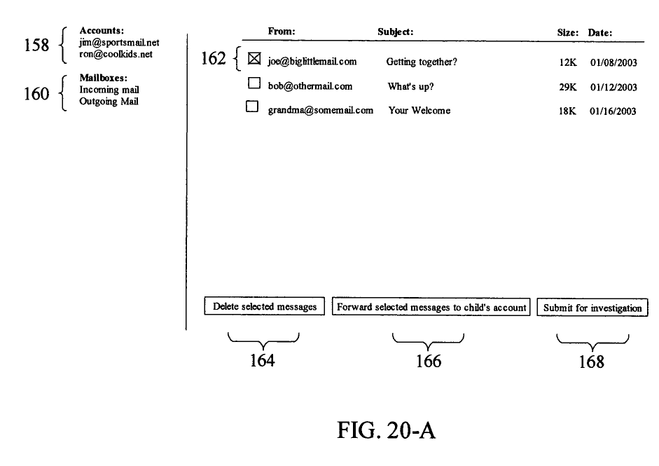

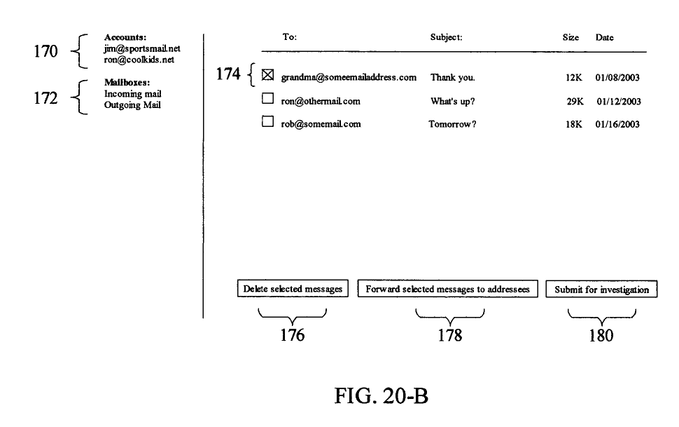

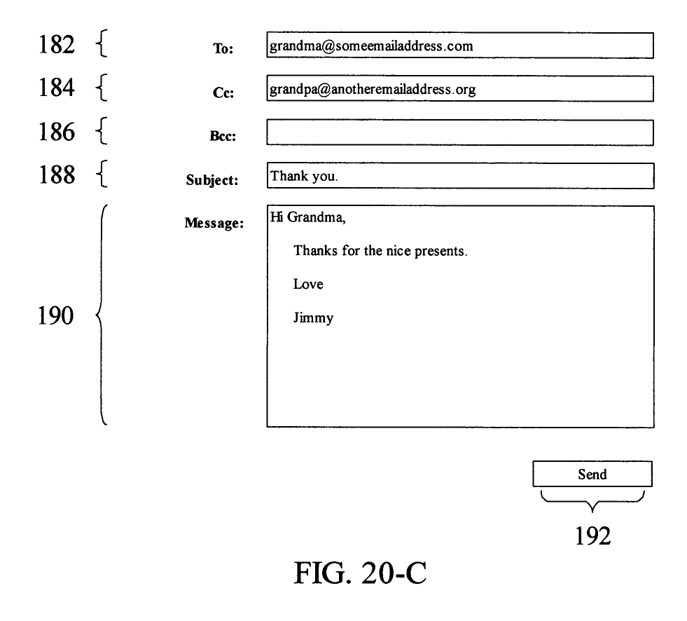

FIGS. 20A-20C illustrate a hierarchical data entry mechanism in one embodiment.

FIG. 20A illustrates a web based interface which enables a parent to review, forward or delete electronic mail messages addressed to the parent's child. A parent selects a child's account to review 158, selects “Incoming mail” 160, selects one or more electronic mail messages addressed to the parent's child 162, and deletes the selected electronic mail messages by clicking the “Delete selected messages” button 164, forwards the selected electronic mail messages to the child's electronic mail account by clicking the “Forward selected messages to child's account” button 166 or sends a copy of the electronic mail messages to an authority by clicking the “Submit for investigation” button 168.

FIG. 20B illustrates a web based interface which enables a parent to review, forward or delete electronic mail messages sent from a child. A parent selects a child's account to review 170, selects “Outgoing mail” 172, and selects one or more electronic mail messages send by the parent's child 174, the parent then deletes the selected electronic mail messages by clicking on the “Delete selected messages” button 176, forwards the selected electronic mail messages to the messages addressees by clicking on the “Forward selected messages to addressees” button 178 or sends a copy of the electronic mail messages to an authority by clicking on the “Submit for investigation” button 180.

FIG. 20C illustrates a web interface to enable a child to compose and send an electronic mail message. A child using a Web Based Electronic Mail Client adds one or more electronic mail addresses into the “To:” field of the electronic mail message 182. If the child wishes to send a carbon copy of the electronic mail message to other individuals, the child adds one or more electronic mail addresses into the “Cc:” field of the electronic mail message 184. If the child wishes to send a blind carbon copy of the electronic mail message to other individuals, the child adds one or more electronic mail addresses into the “Bcc:” field of the electronic mail message 186. The child enterers a subject into the “Subject” field 188, enters the body or content of the electronic mail message into the “Message” field 190 and clicks the send button 192. The send button instructs the child's Web Browser 36 to send the electronic mail message to the Web Server 56 for processing.

1. A method of controlling an electronic mail message addressed and sent to a child, the method comprising:
under control of a computing device,
intercepting an electronic mail message sent to the electronic mail account of a child;
redirecting said electronic mail message to the electronic mail account of said child's parent; and
under control of said parent's computing device,
sending said electronic mail message from the electronic mail account of said parent to the electronic mail account of said child
whereby said child is prevented from receiving electronic mail messages deemed inappropriate by said parent.

2. The method of claim 1 wherein said electronic mail account is any computing device capable of sending and receiving electronic mail messages.

3. The method of claim 2 wherein said parent is any individual or group of individuals.

4. The method of claim 1 wherein said parent is any individual or group of individuals.

5. The method of claim 4 wherein the electronic mail account is any computing device capable of storing and retrieving electronic mail messages.

6. The method of claim 1 wherein said child is any individual or group of individuals.

7. The method of claim 6 wherein said parent is any individual or group of individuals.

8. The method of claim 7 wherein the electronic mail account is any computing device capable of storing and retrieving electronic mail messages.

9. The method of claim 1 wherein the electronic mail account is any computing device capable of storing and retrieving electronic mail messages.

10. The method of claim 1 wherein said child is an authority.

11. A method of controlling an electronic mail message sent from a child, the method comprising:
under control of a computing device,
intercepting an electronic mail message sent from the electronic mail account of a child;
redirecting said electronic mail message to the electronic mail account of said child's parent; and
under control of the parent's computing device,
sending said electronic mail message from the electronic mail account of said parent to the electronic mail message's addressees
whereby said child is prevented from sending electronic mail messages deemed inappropriate by said parent.

12. The method of claim 11 wherein said electronic mail account is any computing device capable of sending and receiving electronic mail messages.

13. The method of claim 12 wherein said parent is any individual or group of individuals.

14. The method of claim 11 wherein said parent is any individual or group of individuals.

15. The method of claim 14 wherein said electronic mail account is any computing device capable of storing and retrieving electronic mail messages.

16. The method of claim 11 wherein said child is any individual or group of individuals.

17. The method of claim 16 wherein said parent is any individual or group of individuals.

18. The method of claim 17 wherein the electronic mail account is any computing device capable of storing and retrieving electronic mail messages.

19. The method of claim 11 wherein the electronic mail account is any computing device capable of storing and retrieving electronic mail messages.

20. The method of claim 11 wherein said child is an authority.
